(19) United States
(12) Patent Application Publication
(10) Pub. No.: US 2018/0001361 A1
(43) Pub. Date: Jan. 4, 2018

(54) PRESSING TOOL PART AND DEVICE FOR ELIMINATING FLATNESS DEFECTS ON PLANAR SEMIFINISHED PRODUCTS

(71) Applicant: SMS group GmbH, Düsseldorf (DE)

(72) Inventors: Roman DEHMEL, Grevenbroich (DE); Frank WERNER, Heiligenhaus (DE)

(73) Assignee: SMS group GmbH, Düsseldorf (DE)

(21) Appl. No.: 15/537,503

(22) PCT Filed: Dec. 2, 2015
(86) PCT No.: PCT/EP2015/078276

§ 371 Date: Jun. 19, 2017

(30) Foreign Application Priority Data
Dec. 19, 2014 (DE) 10 2014 226 519.3

(51) Int. Cl. B21B 37/42; B21D 1/05; B21D 1/06; B21B 38/02; B21D 3/10; B21D 37/10; B30B 15/04; B21B 15/00; B29C 53/04

(52) U.S. Cl. CPC B21B 37/42; B21D 3/10; B21D 1/05; B21D 1/06; B21D 37/10; B21B 38/02; B21B 2015/0071; B29C 53/043; B30B 15/041

(57) ABSTRACT

A pressing tool part for eliminating a flatness defect on a flat semi-finished product provided with a pressing surface facing the flat semi-finished product. The pressing tool includes part half segments separated from each other by a material weakening, which are connected to one another on the one hand to by an elastically bendable bending bridge region of the pressing tool part, and on the other hand to a common actuator in order to elastically deform the pressing surface of the pressing tool part as a function of the flatness defect.

The invention relates to a pressing tool part for eliminating a flatness defect on a flat, semi-finished product with a pressing surface facing the flat, semi-finished product.

The invention further also relates to a device for eliminating flatness defects on flat, semi-finished products, in particular a straightening press, with a machine frame on which a press ram is mounted so that it can be moved in the pressing direction against a press table, and which is provided with a press tool comprising at least one pressing surface having a press tool part by means of which flatness defects can be eliminated on the flat, semi-finished product.

Generic straightening presses are already known from prior art, such as for example those that are used to eliminate a flatness defect on a flat, semi-finished product, for example on rolled semi-finished products, such as for instance sheet metal products, so that these semi-finished products can be delivered to customers without adverse effects on the mechanical characteristic of the surface or the like.

Such flatness defects occur fobr example during the course of the rolling processes, or during heat treatments or the like and they may result in particular in bumps, dips, transverse arches, center and edge waves, skip-ups or the like on the planar semi-finished product.

Straightening presses, which are in particular used for straightening thick plates, include in this case straightening press tools consisting for example of two press tool parts mutually displaceable to one another, of which at least one can be moved in the vertical direction, which is to say in the upward or downward direction, electromechanically or hydraulically in a machine frame of the straightening press.

To this extent, respective flatness defects that are present on a planar semi-finished product are removed or at least reduced to a sufficient degree by means of a vertical press with the pressing operation of a suitably configured press tool.

However, the required pressing forces, which are quite high, can lead to plastic deformation of the flat semi-finished product with such a pressing tool, in particular in the edge regions, which usually results in a devaluation of the quality of the flat semi-finished product due at least to the resulting occurrences of surface damage.

The positioning of the flatness defect region relating to the press tools is presently carried out in part in a semi-automatic operation, wherein the position of the flatness defect on the flat semi-finished product is as a rule determined by means of a flatness measuring device.

The actual straightening process for reducing the flatness defects is ultimately performed by an operator of the straightening press.

However, this procedure is very time-consuming and the success of a flatness defect reducing procedure depends to a large extent on the individual experience of the operator.

It often occurs that the removal of flatness defects is carried out also with the additional use of counter-bearings, which are arranged for example so that they can be pivoted on a machine frame, on a press table, or on a press ram. The disadvantage here is that in their height position, which is to say in the vertical direction, they cannot be optimally adjusted in order to optimally reduce the flatness defect also in the edge regions of the press tool.

The object of this invention is to further develop conventional press tool parts that are used to eliminate a flatness defect on a planar semi-finished product, as well as devices incorporating press tool parts for the elimination of a flatness defect in a planar semi-finished product so as to at least overcome the disadvantages mentioned above.

The object of the invention is achieved with a press tool part for eliminating a flatness defect on a planar half-finished product having a pressing surface facing the planar semi-finished product, wherein the pressing tool part is provided with part half portions that are mutually separated from one another by a weakening of the material, which are on the one hand operationally mutually connected to one another by means of an elastically bendable bridge region of the pressing tool region, and on the other hand mutually connected with a common actuator in order to elastically deform the pressing surface of the pressing tool part in dependence on the flatness defect.

With this construction of the pressing tool according to the invention, it is structurally possible in terms of the first aspect of the present invention to adjust in a very simple manner a deformable pressing tool in a straightening press of an employed pressing tool optimally with respect to an existing flatness defect in order to remove it with no or with very few quality limitations.

It is preferred when the pressing tool part is subdivided into two operationally interconnected part half portions, wherein the deformable pressing tool part is divided in the direction that is transverse to the transport direction of the planar semi-finished product with a weakening of the material.

With the weakening of the material, the pressing tool part undergoes a structural weakening, so that it can be deformed or bent more easily.

It is understood that the deformable pressing tool part can be also provided with a plurality of part half portions when this is advantageous with respect to a straightening press.

As a rule, two such pressing tool parts form together a pressing tool of a straightening press that is used to remove flatness defects from a planar semi-finished tool, wherein one of the pressing tool parts is associated mostly with a stationary press table, and one of the pressing tool parts is associated with a press ram that is movable on the pressing table, while deviations therefrom and other structural variants are of course also possible.

In essence, the present pressing tool is therefore a straightening pressing tool, by means of which flatness defects can be eliminated. To this extent, the invention relates in particular to a straightening pressing tool part for flatness defects.

The expression “bending bridge region” described in the context the invention relates to a physical connection by means of which the half portion sections of the part can be mutually joined together.

The half portion sections of the part and the bending bridge region preferably form a physical unit. For example, they can be materially bonded to each other.

Additionally, however, other types of connections can be also provided.

In the present case it is extremely advantageous when the common actuator is arranged on the part half portions in such a way that an elastic deformation of the pressing surface or of the pressing tool part can occur also while bypassing the pressing forces that are applied for eliminating flatness defects.

In other words, this means that the pressing surface can be elastically deformed in particular without having to apply pressing forces between a planar semi-finished product, such as a sheet metal or a thick plate, and the pressing tool part.

To this extent, the deforming forces or bending forces acting on the pressing tool part that are required within the context of this invention are applied through the common actuator.

For this purpose, the forces applied by the actuator can be maintained smaller when the press ram is constructively designed in such a way so that it can deform with the aid of deformation or with the aid of bending more easily as a function of the work forces to be applied by the actuator, and in particular with bending. Such deformation or bending aids may be designed in many forms, for example by means of a suitably designed hinge device.

It is particularly expedient when the common actuator is attached directly to the part half portions, so that a deformation of the pressing tool part and thus also of the pressing surface can be carried even more precisely because an extremely play-free connection can be achieved in the present case.

If the mutually separated part half portions are operationally connected to one another by means of the common actuator, other structural components of the component groups can be dispensed with.

The actuator can communicate, preferably without a transmission, with the part half portions of the pressing tool part when the common actuator is supported or carried by the pressing tool part.

The present pressing tool part can be designed in a very compact manner when the common actuator is integrated in the pressing tool part. It is preferred when the actuator is integrated in the pressing tool part in such a way so that it is arranged inside one of the envelopes created by the pressing tool part, wherein this envelope is defined by the outer boundary of the pressing tool part.

It is understood that the present actuator can be configured in various ways. Therefore, the actuator may include a drive motor that is operated for example electrically or pneumatically.

It is preferred when the common actuator comprises a hydraulic cylinder unit, so that sufficiently high operating forces can be provided without any problems with the actuator, again to make it possible to apply sufficiently high deformation, bending and also pressing force in order to eliminate flatness defects.

It has been further also shown that a deformation of the pressing tool part or of the pressing surface can be achieved with surprisingly low structural expense when the common actuator comprises a cylinder chamber that is configured with one of the part half portions of the pressing tool.

In this context it is advantageous when the common actuator comprises a piston element, wherein a first end of the piston element is interactively connected to the first part half section of the pressing tool part, and a second end of the piston element is interactively connected to the second part half portion segment of the pressing tool part.

With such a configuration of the construction, the part half portions of the pressing tool part can be also connected in the construction to each other in a simple manner, in addition to being connected also to the elastically bendable bridge section.

Due to the present compact construction of the pressing tool part that comprises the actuator, the pressing tool part itself can be used without any problem when it is employed in a moving functional component, such a press ram, a straightening press or the like. In this respect, an advantageous embodiment variant is provided, wherein the common actuator is arranged by means of the pressing tool part on a movable press ram of a device for eliminating flatness defects on a flat semi-finished product, or on a press table.

In order to make it possible to control the actuator provided on the pressing tool part with only a small structural expenditure, it is advantageous when the pressing tool part comprises a fluid connection device for operating fluidically the common actuator.

It is understood that a similar fluid connection device can be realized in diverse ways. For example, it can be easily implemented by means of a fluid line system that is attached to the pressing tool part.

The fluid connection line can be configured so that it is particularly well protected against external influences when the fluid line system is arranged as a structural component or as groups of structural components that are arranged in the pressing tool part, for example by means of bores or other cavities created in the pressing tool part.

The present pressing tool part can be attached even more easily to a movable press ram or the like of a straightening press when the pressing tool part comprises a divided support frame part, in which the common actuator is integrated.

The present part half portions of the pressing tool part can be designed in almost any way. It is preferred when the pressing tool part is subdivided by means of weakened material into two part half portions having the same size, so that the elastic deformation of the pressing tool part or of the pressing surface is easier to calculate.

The level of control over the targeted pressing forces can be significantly improved when the material weakening section extends, starting from the elastically bendable bending bridge region, along a direction that is perpendicular to the pressing surface level.

Elastic deformation of the pressing tool part that can be achieved with the present actuator can be attained independently of a corresponding deformation of a holding device used for holding the pressing tool part when the part half portions of the pressing tool part are movably mounted on a press ram.

In addition to the first aspect relating to a good elastic deformability of the pressing surface of the pressing tool part, or of the pressing tool per se, it is according to another aspect of the invention also advantageous when the rigidity of the pressing tool part can be manipulated in order to optimally adjust the pressing tool of a deformable pressing tool part of a straightening press for existing flatness defects, and so as to eliminate them with no limitations or only negligible quality limitations.

In this context, in accordance with this aspect, which is independent from the other features of the invention, it is advantageous when the pressing tool part means comprises a tool for influencing the rigidity of the pressing tool part.

It is preferred when this means for influencing the rigidity is configured such that the pressing tool part, and in particular the pressing surface of this pressing tools, can be manipulated with respect to the rigidity, at least in some regions, as a function of a flatness defect on a flat semi-finished product.

It is understood that such means for influencing the rigidity can be realized in different ways to make it possible to produce at least in some region a matching rigidity that matches the flatness defects on the pressing tool part.

At this point, it should be clearly pointed out that the contour of the pressing tool part can be obviously also changed with the means for influencing the rigidness, cumulatively or alternatively. In this respect, the means for influencing rigidity are thus also a means for changing the contour of at least the pressing surface of the pressing tool part.

It is understood that the actuators can be designed so as to influence the rigidity in different ways.

According to a first embodiment variant, the means for influencing the rigidity of the pressing tool part comprise at least one pressure chamber that is integrated in the pressing tool part. Due to the different pressures in the pressure chamber, the pressing tool part and thus also the pressing surfaces exhibiting different interactions with the planar semi-finished product can be designed with different rigidity within the meaning of this invention.

Such a pressure chamber can be particularly well integrated into the pressing tool part so that the pressing tool can be designed with a small construction expense despite the integration of the means for influencing the rigidity.

The different pressure in a pressure chamber, which is accommodated in the pressure tool part, can achieved for example by means of a pressure adjusting device that is arranged outside of the pressing tool part.

Examples of the means that can be used to influence the rigidity include in this case a pneumatic fluid or a hydraulic fluid.

Alternatively, the means for influencing the rigidity of the pressing tool part can comprise at least one other hydraulic cylinder unit, which is integrated in the pressing tool part.

According to another embodiment variant, the measure for influencing the rigidity of the pressing tool part includes at least one wedge mechanism unit, which is integrated in the pressing tool part, wherein the wedge mechanism unit is equipped with a wedge element that can be displaced relative to the pressing tool part.

The means for a wedge mechanism that is designed in this manner can be also used for a comprehensive reinforcement of the pressing tool part depending on the presence of flatness defects in the flat semi-finished product.

When the movable wedge element is in this case arranged on a displacement surface substantially parallel to the pressing surface, the means for influencing stiffness may be also provided with a very flat design.

So that the pressing tool part could be installed with a different rigidity in particular in the areas lateral to its corner regions, it is advantageous when the cavities of the pressing tool part are provided so as to make it possible to accommodate means for influencing rigidity, which are arranged in the corner regions of the pressing tool part.

According to another aspect of the invention, it is advantageous when the pressing tool part comprises a holding-down device that is translationally movable perpendicularly to the pressing surface of the pressing tool part, which holds down the pressing tool part so that an adjustment of the height of the holding-down device with respect to the pressing tool part can take place also when the pressing surface of the pressing tool part is already in operational contact with the flat semi-finished product.

When the holding-down parts, which are supported on the pressing tool part, are translationally movable perpendicularly to the pressing surface of the pressing tool part, a height adjustment with respect to the pressing tool part can be taken into account and carried out even when the pressing surface of the pressing tool part is already in operational contact with the flat semi-finished product.

The actuators can be also designed for moving the holding-down part in different ways.

The pressing tool part, in particular a pressing tool part of a generic straightening press, can be further advantageously developed also in this respect, so that the combination of the features relating to the translationally movable holding-down part used for the pressing surface is already advantageous, even without the other features of the invention.

Moreover, an exchange of the pressing tool parts of on a straightening press can take place very quickly and without complications when the pressing tool part comprises a driving device by means of which it can be displaced from a working position defined for the pressing tool to a different position adjacent to the pressing tool position. This also means that the pressing tool part can be further developed in an advantageous manner, in particular with respect to customary straightening presses, even without the other features of the present invention.

It is further also advantageous when the pressing surface of the pressing tool part is designed by means of a pressing surface portion which is provided with a pressing surface width that is greater than the width of flat semi-finished product. In this manner, several flatness defects that are present on a flat semi-finished product can be removed in an ideal manner and at the same time in a pressing process, or at least significantly reduced.

Moreover, an object of the invention is also achieved with a device for eliminating flatness defect on flat semi-finished products, in particular with a straightening press device that is equipped with a machine frame on which is movably mounted a press ram that is movable in the pressing direction relative to a press table, and with a pressing tool pressing tool part comprising at least one pressing surface, by means of which flatness defects on a flat semi-finished product can be removed, wherein the device is provided with a pressing tool part according to at least one of the features described above.

Flatness defects on planar semi-finished products can be advantageously removed by means of the device equipped with the pressing tool part described above quickly and effectively because the pressing tool part can be on the one hand easily and diversely manipulated based on its design and rigidity and simplicity of the construction, while on the other hand, the pressing tool part can be also quickly replaced on the device.

Furthermore, edge waves can be avoided, in particular on flat semi-finished product, when the device is cumulatively or alternatively provided with a tilting device by means of which a pressing tool part is mounted about a tilting axis extending parallel to the pressing surface to enable tilting on the press ram.

It is understood that such a tilting device can be also designed differently. For example, the pressing tool part can be arranged by means of a correspondingly equipped suspension device on the press ram, while the pressing tool part is mounted so that it can be tilted on the press ram about the tilting axis extending parallel to the pressing surface

An even more robust construction can be realized with the tilting device when the tilting device comprises at least one, preferably two hydraulic cylinder units acting between the press ram and the machine frame to achieve tilting about the tilting axis. By means of these hydraulic unit, the press ram can be moved on the one hand in the pressing direction when approximately two hydraulic cylinder units corresponding to each other are controlled in the same manner. On the other hand, the entire press ram can be tilted about the tilting axis supported by the pressing tool frame when the hydraulic cylinder units are controlled differently, so that the press ram is moved on one side differently from the press ram that is located on the opposite side.

Because effects that could not be achieved so far with conventional device that are used for eliminating flatness defects on flat semi-finished products, in particular with conventional straightening presses, can be achieved with this tilting device, other features relating to the tilting devices are advantageous also with respect to the other characteristics of this invention.

It is understood that the features of the solutions described above and in the claims may be, when appropriate, also combined so as to realize the advantages in a correspondingly cumulative manner.

Other features, effects and advantages of the present invention will be explained with reference to the attached drawings and the following description in which is illustrated and described an example of a device for eliminating flatness defects on flat semi-finished products, as well as different pressing tool parts.

The drawings show the following:

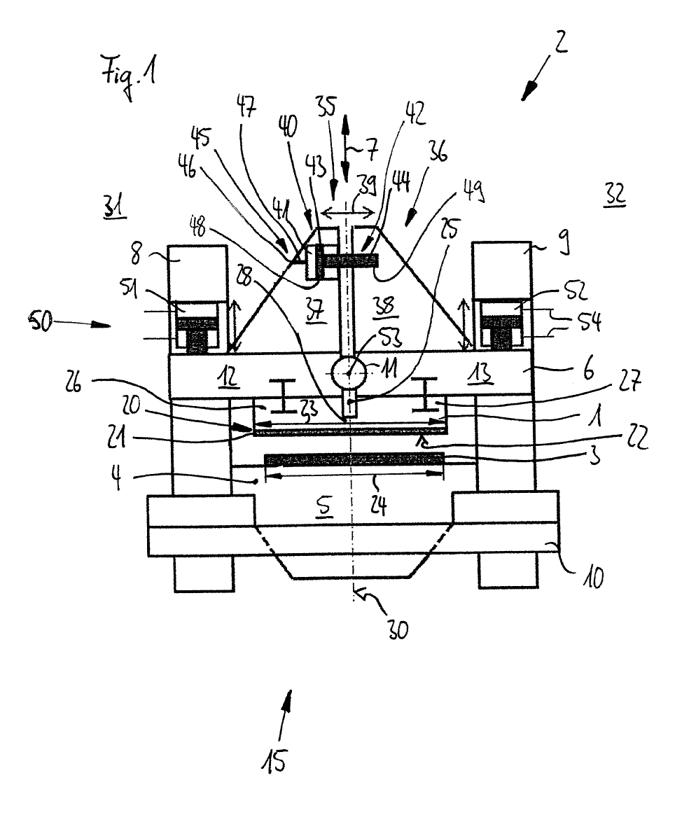

FIG. 1 a schematic drawing showing a view of a straightening press having a pressing tool part according to the invention and a tilting device for tilting this pressing tool part about a tilting axis extending parallel to the pressing surface;

FIG. 2 a schematic drawing showing a view of an alternative of pressing tool part provided with an actuator without a supporting frame for receiving the actuator;

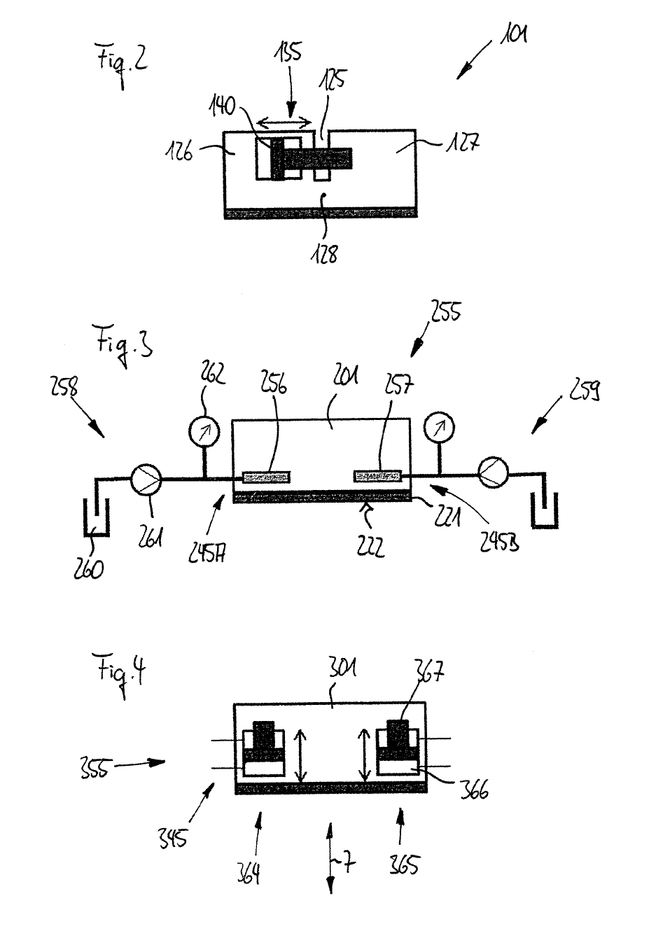

FIG. 3 a schematic view of another pressing tool part provided with means for influencing the rigidity comprising two pressure chambers arranged inside the pressing tool part;

FIG. 4 a schematic view of yet another pressing tool part provided with means for influencing the rigidity comprising two hydraulic cylinder units arranged inside the pressing tool part;

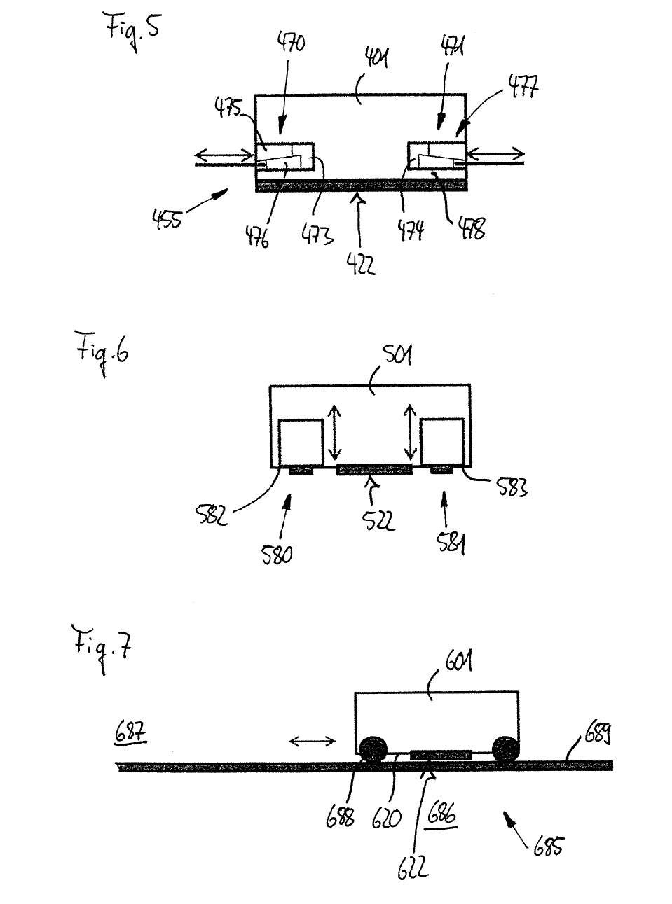

FIG. 5 a schematic view of a pressing tool part with means for influencing the rigidity comprising two wedge mechanism units arranged inside the pressing tool part;

FIG. 6 a schematic view of a pressing tool part provided with holding-down means that is translationally movable perpendicularly to the pressing surface for holding down a flat semi-finished product;

FIG. 7 a schematic view of a pressing tool part provided with a driving device for replacing the pressing tool transversely to a pressing direction.

The pressing tool part 1 shown in FIG. 1 is a component part of a pressing tool employed in an apparatus 2 for eliminating flatness defects (not shown) with a pressing tool on a flat semi-finished product 3 of a pressing tool (not explicitly numbered), and it corresponds to another pressing tool part 4, which is in this embodiment represented below the flat semi-finished product 3 by a press table 5 of the apparatus 2.

On the other hand, the pressing tool 1 is supported on a press table 5 that is movable relative to the press ram 6 and thus above the flat semi-finished product 3, so that the pressing tool part 1 can be moved in the pressing direction 7 to make it possible to exert pressing forces on the flat semi-finished product placed on the press table 5.

In this respect, the press table 5 is fixed and the press ram 6 is displaceably arranged on two stator elements 8 and 9 of a machine frame 10 of the apparatus 2.

Moreover, the press ram 6 is provided with an articulated connection 11, by means of which two press rams 12 and 13 are mutually connected with an articulated connection, so that a higher inherent flexibility is provided for the pres ram 6.

The apparatus 2 for eliminating flatness defects on a flat semi-finished product is configured as a straightening press 15, which is used solely for the purpose of eliminating flatness defects on a flat semi-finished product 3.

In this respect, the pressing tool part 1 is also and preferably exclusively used for eliminating flatness defects on a flat semi-finished product 3. More specifically, the pressing tool part 1 is a flatness defect straightening tool part (not indicated with a separate number).

The pressing tool part 1 is on its lower side provided with a pressing surface region 21, which is configured with a pressing surface 22 facing a flat semi-finished product 3.

So that several flatness defects on the flat semi-finished product 3 could be eliminated in a single pressing operation, or at least in very few pressing operations, the pressing surface region 21 of the pressing tool part 1 is provided with a pressing surface width 23 that is greater than the width 24 of the flat semi-finished product 3.

Further, the pressing tool part 1 is subdivided with a material weakening 25 into two part half portions 26 and 27 that are mutually separated from one another, wherein in this embodiment, an elastic bendable bending bridge region 28 of the pressing tool 1 is also provided under the material weakening 25, by means of which the two part half portions 26 and 27 are physically connected to one another.

The pressing tool part 1 is thus configured in such a way that the material weakening 265 defines a dividing plane 30, wherein the first part half portion 26 is located on a first part side 31 of the dividing plane 30, and the second part half portion 27 is arranged on a second part 32 located on the dividing plane 30 opposite the first side 31.

The material weakening 25 is thus delimited by three inner sides of the pressing tool part 1, in particular by the sides (not additionally labeled with numbers) of the two part half portions 26 and 27 and by the elastically bendable bridge portion 28.

In this respect, the material weakening 25 extends, starting from the elastically bendable bridge region 28, in the upward direction along this dividing plane 30.

The pressing tool part 1 thus undergoes a structural weakening with the material weakening 25, whereby it can be deformed or bent more easily.

The relevant deformation forces or bending forces are applied as working forces with an actuator 35, which is accordingly operationally connected with the two part half portions 26 and 27.

In this first embodiment, the pressing tool part 1 is designed with a divided support frame 36, which is integrally connected with the pressing tool part 1, extending upward and to the right. The advantage obtained in this manner is that the actuator 35 can be arranged further in the upward direction and thus at a distance from the press ram 6.

In this case, the divided support frame 36 is operationally connected via a first frame part half portion 37, which is rigidly connected to the first part half portion 26, and via a second frame part half portion 38, which is rigidly connected to the second part half portion 27.

The first frame part half portion 37 is thus an extension of the first part half portion 26 of the pressing tool part 1, and the second frame part half portion 28 is a corresponding extension of the second part half portion 27 of the pressing tool part 1. The actuator 35 is thus already very well integrated in the pressing tool part 1.

Therefore, since the actuator is arranged by means of the divided support frame part 36 so that it is located further away from the elastically bendable bending bridge region 28, the lever ratios are improved with respect to the actuator 35 and of the elastically bendable bending bridge 28, so that smaller working forces need to be generated by the actuator 35 to make it possible to set the desired deformation on the pressing tool part 1.

Due to these advantageous lever ratios, a smaller design of the actuator 35 can be used because less of the working needs to be exhibited in order deform the pressing tool part 1. This is supported also by the articulated and subdivided press ram 6 because it can perform deformation, and in particular as a function the bending and deforming forces to be applied as working force by the actuator 35.

Furthermore, the accessibility of the actuator 35 is also improved.

Because the divided support frame 36 is rigid rather than articulated, this means that it is connected the actual pressing tool part 1 without the interposition of joints or of a transmission. Thus it can be said that within the context of the present invention, the actuator 35 is attached directly to the part half portions 26 and 27. Therefore, the setting of the forces affecting a deformation or bending operation carried out on the pressing tool part 1 can be performed more precisely because the working forces are applied by the actuator in an ideal manner and without play, in particular when they can be applied in the elastically bendable bending bridge region 28.

In order to perform deforming or bending with the pressing tool 1, the actuator 35 is displaced or shortened according to the movement direction 39 that is perpendicular to the dividing plane 30, so that the two frame half portions 37 and 38 or the two part half portions 26 and 27 can be moved around the elastically bendable bending bridge region 28.

The actuator 35 is thus integrated in this manner in the divided support frame part 36, so that the part half portions 26 and 27 that are separated from one another are mutually connected to each other with an operational connection by means of the actuator 35.

In this first embodiment, the actuator 35 is designed as a hydraulic cylinder unit 40, wherein the cylinder chamber 41 of the hydraulic cylinder unit 40 is formed directly from the first frame part half portion 37 of the divided support frame part 36.

The corresponding piston element 42 of the hydraulic cylinder unit 40 is placed with its piston crown 43 in the cylinder chamber 41 and thus fixed to the first frame part half portion 37.

The piston element 42 of the hydraulic cylinder unit 40 is attached with its piston rod 44 to the second frame part half portion 38.

The actuator 35 or the hydraulic cylinder unit 40 is supplied with a hydraulic fluid by means of a correspondingly configured fluid connection device 45, wherein the fluid connection device 45 comprises at least one input and/or output connection 46 (labeled with a numeral only by way of an example) and at least one fluid line 47 used in order to secure a fluidic connection between the cylinder chamber 41 and a supply unit (not shown).

In this context, a first end 48 of the piston element 42 is interactively connected to the first part half portion 27 of the pressing tool part 1 and to a second end 49 of the piston element 42 with the second half portion 27 of the pressing tool part 1.

In particular, edge waves (not shown) in the flat semi-finished product 3 can be effectively prevented because the present apparatus 2 is cumulatively provided with a tilting device 50 having two further hydraulic cylinder units 51 and 52 arranged between the press ram 6 and the stationary elements 8 and 9 of the machine frame 10.

The press ram 6 and in particular the pressing tool part 1 can be tilted by means of this tilting device 50 about a tilting axis 53 extending parallel to the pressing surface 22 and supported on the press ram 6 or on the machine frame 10, wherein the interaction between pressing tool part 1 and the flat semi-finished product 3 can be used to extend the setting alternatives even further.

The other two hydraulic cylinder units 51 and 52 are respectively provided with hydraulic connections 54 (provided with a numeral only by way of an example), so that a hydraulic fluid can be supplied to them.

In the example of an alternative pressing tool 101 shown in FIG. 2, the support frame part 36 described above is dispensed with, so that the actuator 135 is arranged directly in the form of the hydraulic cylinder unit 140 next to the elastically bendable bending bridge region 128 and integrated in the pressing tool part 101.

Therefore, the construction of the pressing tool part 101 is even more compact, wherein the pressing tool part 101 is subdivided with the material weakening 125 into two part half portions 126 and 127.

These two part half sections 126 and 127 are thus again operationally connected to one another with a bendable bending bridge region 128 and the actuator 135.

As far as the operation of this second embodiment is concerned, reference is made to the embodiment described above so as to avoid repetitions.

According to another embodiment shown in FIG. 3, another pressing tool part 201 is equipped with means 255 for influencing the rigidity of the pressing tool part 201, which can be provided cumulatively or alternatively,

The means 255 for influencing the rigidity comprise in this embodiment two pressure chambers 256 and 257 for receiving hydraulic fluid, which are integrated directly in the pressing tool part 201; and in particular in the immediate vicinity of the pressing surface 222 of the pressing surface region 221.

The means 255 for influencing the rigidity further also comprise two supplying devices 258 and 259, wherein the first supplying device 258 is fluidically connected by means of a first fluid connection device 245A to the first pressure chamber 256 and the second supplying device 259 is fluidically connected by means of a fluid connection device to the second pressure chamber 257, so that each of these two pressure chambers 256 and 257 can be controlled independently from each other, wherein the variety of the regions on the pressing tool part 201 that are provided with different rigidity can be further increased.

Each of the two supplying devices 258 or 259 can be provided with at least one hydraulic fluid reservoir (labeled with a numeral only by way of an example), so that the pressure in the pressure 256 or 257 chambers can be set almost arbitrarily.

Depending on the which pressure level is set in the two pressure chambers 256 or 257, the rigidity of the pressing tool part 1 can be set differently throughout its pressure surface width 223.

Another pressing tool part 301 explained in the FIG. 4 is also provided with a means 355 for influencing the rigidity of the pressing tool part 301, which is further equipped with hydraulic cylinder units 364 and 365 arranged inside the pressing tool part 301 enabling to manipulate the rigidity on the pressing tool part 301. In this case, the cylinder chambers 366 (labeled with a numeral only by way of an example) of the other hydraulic cylinder units 364 and 365 themselves are configured directly with the pressing part tool 301, wherein the piston element 367 (labeled with a numeral only by way of an example), located in the cylinder chamber 366, can be moved with the impact of the hydraulic pressure in the pressing direction 7 (see FIG. 1), in order to set the pressures prevailing in the cylinder chambers 366. For this purpose, the means 355 include fluid connection devices 345 (labeled with a numeral only by way of an example), which are correspondingly designed for influencing the rigidity of the pressing tool part 301.

In the pressing tool part 401 illustrated according to FIG. 5, the means 455 for influencing the rigidity of the pressing tool part 401, which are again realized differently, include two wedge mechanism units 470 and 471, which are respectively arranged via cavities 473 or 474 incorporated in the pressing tool part 401.

Each of the wedge mechanism unit 470 and 471 is equipped with a wedge element 475 (labeled with a numeral only by way of an example), arranged in a fixed manner in the pressing tool part 401, and with an element 476 (labeled by a numeral only by way of an example) displaceable relative to the other element, wherein the mutually interacting wedge elements 475 and 476 are interacting with each other so that the rigidity can be varied as a function of the position of the movable wedge element 476 relative to the stationary wedge element 475.

The stationary wedge element 475 and the movable element 476, which is movable relative to the stationary element, respectively form a wedge pair 477 (labeled with a numeral only by way of an example) of the means 455 for influencing the rigidity of the pressing tool 401, which are placed in each case in the associated cavity 473 or 474 inside the pressing tool parts 401.

The movable wedge element 476 can be in this case moved with a suitably designed hydraulic device, not shown here, to the pressing surface 422, so that a wall section 478 (labeled with a numeral only by way of an example), facing the pressing surface 422 of the cavity 473 or 474 of the pressing tool part 401, can be more or less strongly supported, wherein the rigidity of the pressing tool part 401 can be again varied.

In should be again explicitly pointed out here that the contour of the pressing tool part can be changed cumulatively or alternatively with the means for influencing the rigidity.

Furthermore, another pressing tool 501 shown in FIG. 6 comprises two holding-down devices 580 and 581 that additionally hold down the flat semi-finished product 3 (see also FIG. 1) in the lateral edge regions 582 and 583 of the pressing tool part 501, wherein these holding-down devices 580 and 581 are in this embodiment placed laterally next to the actual pressing surface 522.

The two holding-down devices 580 and 581 are moved in this case laterally to the pressing surface 522 and they are driven to or out of the pressing tool part 501 in a direction that is parallel to the pressing direction 7. The holding-down devices 580 or 581 can be in this case addressed with a suitably designed hydraulic device, not illustrated here.

In the embodiment illustrated in FIG. 7, the pressing tool part 601 is provided with a driving device 685, by means of which the pressing tool part 601 can be displaced from a defined operating position 686, wherein it is mounted in a device 2 (see for example FIG. 1), so that the pressing tool part can be replaced by another pressing tool part 1, 101, 201, 301, 401, 501, etc.

The driving device 685 in this case includes wheels 688 (labeled with a numeral only by way of an example), which are supported on the lower side 620 of the pressing tool 601. Between two wheel pairs (not indicated with a numeral) is arranged the pressing surface 622.

In addition, the driving device 685 also includes a moving path cross member 689, on which the guided wheels 688 are moved.

It should be stated explicitly one more time here that the features of the solutions described above and in the claims and/or the solutions described in figures may be also combined and cumulated as appropriate to make it possible to achieve the characteristics, effects and advantages discussed above.

It is understood that that the embodiments described above are only first configurations of the invention. In this respect, the configuration of the invention is therefore not limited by the embodiments.

All the features disclosed in the application documents are claimed as being essential to the invention, to the extent that they are new individually or in combination with prior art.

### LIST OF REFERENCE SYMBOLS

1 pressing tool part
2 device
3 flat semi-finished product
4 another pressing tool part
press table
6 movable press ram
7 press direction
8 right stationary element
9 left stationary element
11 articulated connection
12 first press ram region
13 second press ram region
15 right press
20 lower side
21 pressing surface region
22 pressing surface
23 pressing surface width
24 width
25 material weakening
26 first part half section
27 second part half section
28 bending bridge region
30 dividing plane
31 first side
32 second side
35 common actuator
36 divided support frame part
37 first frame part half section
38 second frame part half section
39 movement direction
40 hydraulic cylinder unit
41 cylinder chamber
42 piston element
43 piston crown
44 piston rod
45 fluid connection means
46 input and/or output connection
47 fluid line
48 first end
49 second end
50 tilting device
51 a first variant of a hydraulic cylinder unit
52 a second variant of a hydraulic cylinder unit
53 tilting axis
101 an alternative pressing tool part
125 material weakening
126 a first partial half section
127 a second partial half section
128 elastically bendable bending bridge section
135 actuator
140 hydraulic cylinder unit
201 another pressing tool part
221 pressing surface region
222 pressing surface
223 pressing surface width
245A first fluid connection device
245B second fluid connection device
255 means for influencing rigidity
256 first pressure chamber
257 second pressure chamber
258 first supplying device
259 second supplying device
260 hydraulic fluid reservoir
261 supplying pump
262 control valve
301 another pressing tool part
345 fluid connection devices
360 means for influencing rigidity
364 another first hydraulic cylinder unit
365 another second hydraulic cylinder unit
366 cylinder chambers
367 piston element
401 pressing tool part
422 pressing surface
460 means for influencing rigidity
470 first wedge mechanism unit
471 second mechanism unit
473 first cavity
474 second cavity
475 stationary wedge element
476 movable wedge element
477 wedge element pairs
478 wall sections
501 pressing tool part
522 pressing surface
580 first holding-down part
581 second holding-down part
582 first lateral edge region or corner region
583 second lateral edge region or corner region
601 pressing tool part
620 lower side
622 pressing surface
685 driving direction
686 operating position
687 replacement position
688 wheels
689 moving path cross member

1-24. (canceled)

25. Pressing tool par for eliminating flatness defects on a semi-finished product comprising:
a pressing surface, facing the flat semi-finished product, wherein the pressing tool part is provided with part half sections separated from each other with a material weakening, which are on the one hand operationally connected by an elastically bendable bending bridge region of the pressing tool to each other, and on the other had are also operationally connected to a common actuator for elastic deformation of the pressing surface of the pressing tool part in dependence on the flatness defect.

26. The pressing tool part according to claim 25, wherein the common actuator is attached directly to the part half sections.

27. The pressing tool part according to claim 25, wherein the part half sections that are separated from each other are operationally connected to each other by the common actuator.

28. The pressing tool part according to claim 25, wherein the common actuator is supported or carried by the pressing tool part.

29. The pressing tool part according to claim 25, wherein the common actuator is integrated in the pressing tool part.

30. The pressing tool part according to claim 25, wherein the common actuator comprises a hydraulic cylinder unit.

31. The pressing tool part according to claim 25, wherein the common actuator comprises a cylinder chamber, which is equipped with one of the part half sections of the pressing tool.

32. The pressing tool part according to claim 25, wherein the common actuator comprises a piston element, wherein a first end of the piston element is interactively connected to a first part half segment of the pressing tool part and a second end of the piston element is interactively connected to a second part half segment of the pressing tool part.

33. The pressing tool part according to claim 25, wherein the common actuator is arranged by the pressing tool part on a movable ram of a device for eliminating flatness defects on a flat semi-finished product, or on a press table.

34. The pressing tool part according to claim 25, wherein the pressing tool part comprises a fluid connection device for a fluidic operation of the common actuator.

35. The pressing tool part according to claim 25, wherein the pressing tool part comprises a divided support frame part, in which is integrated the common actuator.

36. The pressing tool part according to claim 25, wherein the pressing tool part is subdivided with the material weakening into two of the part half segments having a same size.

37. The pressing tool part according to claim 25, wherein the material weakening extends starting from the elastically bendable bending bridge region along a plane extending perpendicularly to the pressing surface.

38. The pressing tool part according to claim 25, wherein the part half segments of the pressing tool are movably supported in a press ram.

39. The pressing tool part according to one of the claim 25, wherein the pressing tool part comprise means for influencing a rigidity of the pressing tool part.

40. The pressing tool part according to claim 39, wherein the means for influencing the rigidity of the pressing tool part comprise at least one press chamber, which is integrated in the pressing tool part.

41. The pressing tool part according to claim 39, wherein the means for influencing the rigidity of the pressing tool part comprises at least one other hydraulic cylinder unit that is integrated in the pressing tool part.

42. The pressing tool part according to claim 41, wherein the means for influencing the rigidity of the pressing part comprises at least one wedge mechanism unit that is integrated in the pressing tool part, wherein the wedge mechanism unit is provided with at least one wedge element that is movable relative to the pressing tool part.

43. The pressing tool part according to claim 25, wherein the pressing tool part comprises a holding-down device that is translationally movable perpendicularly to the pressing surface of the pressing tool part for holding down the pressing tool part.

44. The pressing tool part according to claim 25, wherein the pressing tool part comprises a driving device, by which it can be moved from an operating position defined via the pressing tool into a changing position located next to the pressing tool.

45. The pressing tool part according to claim 25, wherein the pressing surface of the pressing tool is configured by a pressing surface region, which is equipped with a pressing surface width that is greater than the width of the flat semi-finished product.

46. A device for eliminating flatness defects on flat semi-finished products, comprising:
a straightening press provided with a machine frame on which is mounted a press ram that is movable in a pressing direction opposite a press table, and with a pressing tool comprising a pressing tool part equipped with at least one pressing surface, by which can be removed flatness defects on a flat semi-finished product, wherein the device is equipped with a pressing tool part.

47. The device according to claim 46, wherein the device is provided with a tilting device by which the pressing tool part is tiltably mounted about a tilting axis that is extending parallel to the pressing surface on the press ram or on the machine frame.

48. The device according to claim 47, wherein the tilting device comprises at least one, hydraulic cylinder unit acting between the press ram and the machine frame in order to tilt the press ram about the tilting axis.
